(19) United States
(12) Patent Application Publication
(10) Pub. No.: US 2025/0136081 A1
(43) Pub. Date: May 1, 2025

(54) METHOD FOR OPERATING A HYBRID VEHICLE AND HYBRID VEHICLE

(71) Applicant: Ford Global Technologies, LLC, Dearborn, MI (US)

(72) Inventors: Guenter Grosch, Vettweiß (DE); Krystian Dylong, Cologne (DE); Rainer Kiehn, Frechen (DE); Georg Louven, Neuwied (DE)

(21) Appl. No.: 18/918,801

(22) Filed: Oct. 17, 2024

(30) Foreign Application Priority Data
Oct. 25, 2023 (DE) 102023129358.3

(51) Int. Cl. B60W 20/00; B60H 1/14; B60H 1/22; B60W 10/26; B60W 10/28; H01M 8/04228; H01M 8/04303; H01M 8/04537; H01M 8/04955; H01M 10/44; H01M 10/46; H01M 16/00

(52) U.S. Cl. CPC B60W 20/00; B60W 10/26; B60W 10/28; H01M 8/04228; H01M 8/04303; H01M 8/04626; H01M 8/04955; H01M 10/44; H01M 10/46; H01M 16/006; B60H 1/143; B60H 1/2215; B60W 2510/244; H01M 2220/20; H01M 2250/20; H01M 2250/402

(57) ABSTRACT

The disclosure relates in general to a method for operating a hybrid vehicle and to a hybrid vehicle which has a fuel cell and an energy store. A state-of-charge of the energy store of the hybrid vehicle is monitored when the hybrid vehicle is at a standstill. The fuel cell is operated when the hybrid vehicle is at a standstill to charge the energy store, responsive to the state-of-charge of the energy store falling below a first state-of-charge threshold value. Waste heat is generated by the operation of the fuel cell. A vehicle interior of the hybrid vehicle and/or a luggage compartment of the hybrid vehicle is heated using the generated waste heat and/or using an electric heating element for which a first supply current from the energy store is provided.

### RELATED APPLICATIONS

The present application claims priority to German Application No. 102023129358.3, filed Oct. 25, 2023. The entire contents of the above-referenced application are hereby incorporated by reference for all purposes.

### FIELD

The disclosure relates in general to a method for operating a hybrid vehicle and to a hybrid vehicle.

### BACKGROUND/SUMMARY

If the outside temperature is too low, vehicle interiors, or in certain circumstances also the luggage compartments of vehicles, may be heated, even during driving breaks in which the vehicle is at a standstill.

In known vehicles, an auxiliary heating system is typically used for this purpose, which system has an independent combustion space by means of which the cooling water may be heated. In electrically powered vehicles, an electrically operable heating element may be used for this purpose, although this reduces the state-of-charge of an energy store, with the result that the range is limited.

US 2015/298523 A1 discloses a vehicle having an additional heating system which has a park mode for heating a passenger compartment of the vehicle. The additional heating system may comprise a fuel-based heating system and also an electric heating element. The additional heating system is deactivated if the fuel level and/or state-of-charge of the battery falls below respective threshold values. If the state-of-charge of the battery is lower than the threshold value, it cannot be raised again. In the case of permanently low temperatures, a further discharging of the battery may occur, with the result that a minimum state-of-charge of the battery can no longer be guaranteed. Since the battery is used to start the vehicle, even in the case of the internal combustion engine, the functionality of the vehicle cannot be guaranteed.

JP 2011031704 A discloses an air-conditioning system for hybrid vehicles. The hybrid vehicle comprises an internal combustion engine and a battery which supplies an electric motor with electrical energy. The air-conditioning system has a coolant circuit with vapor compression and a warm-water heating system. The warm-water heating system heats the blown-in air by using the coolant of the internal combustion engine as a heat source. The internal combustion engine is used if the remaining battery voltage is below an expected threshold. The electric motor may be stopped if the battery state is insufficient. In this way, the temperature of the coolant may be increased at a point in time. The heating may then be continued without interruption, even if the residual capacity of the battery decreases. However, this does not make it possible to increase the state-of-charge of the battery. In addition, the document does not address the object of guaranteeing an appropriate temperature while the vehicle is at a standstill.

EP 3 055 154 A1 discloses a hybrid vehicle which has an internal combustion engine, a generator, an electric storage device, an electric motor, an electronic control device and a heating device which heats a vehicle cabin. The electronic control device controls the travel of the vehicle by selective application of a CD mode, in which a state-of-charge of the electric storage device is reduced, and a CS mode, in which the state-of-charge is maintained. The electric heating system heats the vehicle cabin by using the electrical energy which is stored in the electric storage device. The electronic control device controls the electric heating system in such a way that the heating by the electric heating system in the CS mode is reduced in comparison with the CD mode. This means that the heating output in the CS mode is reduced. As a result, a consistent temperature in the vehicle interior cannot be guaranteed in certain circumstances.

Thus, embodiments are disclosed herein to provide a new way to ensure consistent desired temperature control of vehicle interiors. In one example, a method operating a hybrid vehicle which has a fuel cell and an energy store includes monitoring a state-of-charge of the energy store of the hybrid vehicle when the hybrid vehicle is at a standstill, operating the fuel cell when the hybrid vehicle is at a standstill to charge the energy store, responsive to the state-of-charge of the energy store falling below a first state-of-charge threshold value, wherein waste heat is generated by operating the fuel cell, and heating a vehicle interior of the hybrid vehicle and/or a luggage compartment of the hybrid vehicle using the generated waste heat and/or using an electric heating element for which a first supply current from the energy store is provided. In this way, a consistent desired temperature control of a vehicle interior and/or of a luggage compartment of the hybrid vehicle is guaranteed, and in which it can be permanently guaranteed that the state-of-charge of an energy store does not fall below a desired minimum state-of-charge.

As a result, a method is created by means of which the state-of-charge of the energy store is increased again after it falls below the first state-of-charge threshold value. In this way, it can be permanently guaranteed that the energy store has a minimum state-of-charge, even in the case of permanently low outside temperatures. Such outside temperatures may otherwise result in further discharging of the energy store. It is therefore also guaranteed that the energy store has such a sufficient state-of-charge that it can be used to start the vehicle after the vehicle has been at a standstill (e.g., during vehicle start-up following a vehicle shutdown). Energy from the energy store may be used to start a power unit, for example in order to preheat various components. In addition, increasing the state-of-charge of the energy store also increases the range of the hybrid vehicle, insofar as it is powered on the basis of the electrical charge of the energy store.

The waste heat generated during operation of the fuel cell is normally lost as heat loss. Here, however, it is used advantageously to heat the vehicle interior and/or the luggage compartment. As a result, the load on the energy store is reduced. In addition, redundancy is created with regard to the possible heating mechanisms.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The disclosure and further advantageous embodiments and developments of the same will be described and explained in more detail hereinafter with reference to the examples depicted in the drawings. In the drawings:

FIG. 1 shows a simplified schematic depiction of a hybrid vehicle according to an embodiment of the present disclosure,

FIG. 2 shows a simplified schematic depiction of a method for operating the hybrid vehicle according to an embodiment of the present disclosure,

FIG. 3 shows a simplified schematic depiction of operating states of the hybrid vehicle in conjunction with the method according to an embodiment of the present disclosure,

FIG. 4 shows a simplified schematic depiction of a process diagram for operating the fuel cell and the electric heating element in conjunction with the method according to an embodiment of the present disclosure, and

FIG. 5 shows a simplified schematic depiction of a process diagram for selecting an energy source for the powering of the hybrid vehicle in conjunction with the method according to an embodiment of the present disclosure.

### DETAILED DESCRIPTION

The following description relates to a systems and methods for selectively operating a fuel cell to control the state of charge of an energy store of a vehicle in order to maintain the temperature of the vehicle interior and/or luggage compartment within a desired range, while also maintaining the state of charge of the energy store within an acceptable range. For example, as disclosed herein, a method for operating a hybrid vehicle which has at least one fuel cell and an energy store may include monitoring a state-of-charge of the energy store of the hybrid vehicle when the hybrid vehicle is at a standstill, operating the fuel cell when the hybrid vehicle is at a standstill to charge the energy store, at least as long as the state-of-charge of the energy store falls below a first state-of-charge threshold value, wherein waste heat is generated by the operating of the fuel cell, and heating a vehicle interior of the hybrid vehicle and/or a luggage compartment of the hybrid vehicle using the generated waste heat and/or using an electric heating element for which a first supply current from the energy store is guaranteed.

In some embodiments, the operation of the fuel cell is terminated responsive to the state-of-charge of the energy store exceeding a second state-of-charge threshold value. The vehicle interior and/or the luggage compartment is then heated exclusively using the electric heating element, on the basis of the energy store. If the state-of-charge of the energy store has been increased sufficiently by the operation of the fuel cell, the fuel cell may be deactivated. However, the temperature control of the vehicle interior and/or of the luggage compartment may continue to be constantly guaranteed, because it is made possible in this case by the electric heating element using the energy store. As a result, fuel, for example hydrogen, which is provided for the fuel cell, may advantageously be saved for later use.

The second state-of-charge threshold value is preferably greater than the first state-of-charge threshold value. In this way, it is guaranteed that the temperature control of the vehicle interior and/or of the luggage compartment takes place exclusively on the basis of the energy store only when the state-of-charge thereof has increased relative to the point in time of the activation of the fuel cell.

The operation of the fuel cell is optionally reactivated, responsive to the state-of-charge of the energy store falling below a third state-of-charge threshold value. The third state-of-charge threshold value is less than the second state-of-charge threshold value. Since the vehicle interior and/or the luggage compartment is heated exclusively on the basis of the energy store, the state-of-charge of the energy store falls again. Therefore, after the third state-of-charge threshold value is undershot, it may be envisioned that the fuel cell is reactivated in order to increase the state-of-charge of the energy store again.

In some examples, the third state-of-charge threshold value and the first state-of-charge threshold value may match.

Alternatively, the third state-of-charge threshold value and the first state-of-charge threshold value may also be different. For example, the third state-of-charge threshold value may be greater or less than the first state-of-charge threshold value.

By suitably selecting the state-of-charge threshold values, an interval with respect to the state-of-charge of the energy store may be defined, within which the state-of-charge is held permanently, for example by selectively activating the fuel cell.

In some embodiments, the fuel cell is operated intermittently. This means that the fuel cell is activated and deactivated multiple times within a reference time interval. The reference time interval may be one hour, for example, or 30 minutes, or also 10 minutes. During operation of the fuel cell, a coolant is used in order to hold the temperature of the fuel cell in a standard interval. The coolant heats up through operation of the fuel cell, with the result that the waste heat is generated. By operating the fuel cell intermittently, the temperature of the coolant may be held within an envisioned temperature range. As a consequence, a constant quantity of generated waste heat may be generated, which can be used to heat the vehicle interior and/or the luggage compartment. As a result, the operation of heating the vehicle interior and/or the luggage compartment may take place more evenly during the operation of the fuel cell. In particular, by adjusting the operating intervals of the fuel cell, the temperature range of the coolant may be selected in such a way that the efficiency of the heat transfer for heating the vehicle interior and/or the luggage compartment is optimized.

The hybrid vehicle optionally has an air-conditioning device which is operated at least temporarily using the waste heat and at least temporarily using the first supply current. Expressed another way, the air-conditioning device is designed to emit heat to the vehicle interior and/or the luggage compartment, and specifically on the basis of either the waste heat which is produced during operation of the fuel cell and/or heat which is produced by operation of the at least one electric heating element.

The air-conditioning device may include at least one heat exchanger which is coupled at least indirectly to the electric heating element. The heat exchanger may be designed to be operated at least indirectly using the coolant which is used to cool the fuel cell when it is being operated. It is thus also clear that the coolant may have an optimized coolant temperature at which the efficiency of the heat exchanger is optimized. Here it can be seen that operating the fuel cell intermittently is advantageous for setting the coolant temperature and thus for optimizing the efficiency of the heating of the vehicle interior and/or of the luggage compartment.

In some embodiments, the hybrid vehicle has a cooling device which is operated at least temporarily using a second supply current which is produced by the fuel cell or guaranteed by the energy store. In particular, it may be advantageous for the luggage compartment of the hybrid vehicle to be kept at a temperature which is lower than an outside temperature. For operation, a cooling device is then used, the supply current for which may be provided both by the fuel cell and by the energy store. In particular, the second supply current may then be provided by the energy store if the state-of-charge thereof does not fall below the first state-of-charge threshold value and/or the third state-of-charge threshold value. As long as the fuel cell is operated in order to increase the state-of-charge of the energy store again, part of the output current produced by the fuel cell may be used to operate the cooling device. As a result, the electrical load on the fuel cell is increased, which advantageously leads to higher efficiency of the fuel cell. Fuel cells generally have a higher level of efficiency when there are higher electrical loads.

Alternatively, it is also conceivable for the second supply current to be provided proportionally by the fuel cell and the energy store.

Optionally a control device is provided, which controls the operation of the fuel cell and of the energy store. The control device is coupled to a trajectory planner. The control device, knowing when the standstill of the hybrid vehicle is to occur, prevents operation of the fuel cell before the vehicle is at the standstill, so that locomotion of the hybrid vehicle is guaranteed exclusively on the basis of the energy store.

Optionally, the decision as to whether the hybrid vehicle is powered exclusively on the basis of the energy store may depend on a time interval until the planned standstill of the vehicle. For example, the control device may be designed to guarantee the powering of the hybrid vehicle exclusively on the basis of the energy store if a time interval of 30 minutes until the planned standstill is undershot. In other examples, the time interval until the planned standstill that is undershot may be 40 minutes, 60 minutes, or another time period. The time interval may also be adjustable by a user input. In this way, the hybrid vehicle may be propelled by the fuel cell or the energy store, based on the state of charge of the energy store, until the current time reaches the time interval before the planned standstill. Once the current time reaches the time interval, the hybrid vehicle may be propelled solely based on the energy store for the remaining duration until the planned standstill. Accordingly, 30-60 minutes before the planned standstill, the hybrid vehicle may be propelled using the energy in the energy store. Prior to the time interval before the planned standstill, the hybrid vehicle may be propelled by energy from the fuel cell and/or the energy store. The planned standstill may be a final destination of the hybrid vehicle, determined from the user input/trajectory planner, where it is anticipated that the hybrid vehicle may be stopped and in some examples shut down.

Additionally, the decision as to whether the hybrid vehicle is powered exclusively on the basis of the energy store may depend on the state-of-charge of the energy store. The state-of-charge may be greater than a minimum state-of-charge of the energy store, so that the vehicle can be powered exclusively on the basis of the energy store and the control device may control the hybrid vehicle correspondingly. The minimum state-of-charge may correspond to the first state-of-charge threshold value, for example.

The hybrid vehicle has an electric motor. To operate the electric motor, a supply current is used. The supply current for operating the electric motor may be provided by the fuel cell and/or the energy store. Since the control device is coupled to the trajectory planner, it knows when a standstill of the vehicle is to be expected. This may be due, for example, to the fact that it may be known that a planned route is being ended or the driver wishes or has to take a break. For example, truck drivers are to follow with prescribed rest periods (breaks) in which the vehicle is parked. Knowing the expected standstill of the vehicle, the control device may therefore control the onboard electrical system of the hybrid vehicle in such a way that the supply current for operating the electric motor is provided exclusively by the energy store. As a result, fuel of the fuel cell, for example hydrogen, may be saved. If the state-of-charge of the energy store subsequently falls below the first state-of-charge threshold value while the vehicle is at a standstill, the fuel cell may be activated in order to increase the state-of-charge again. Fuel of the fuel cell thus may advantageously still be saved, at least initially.

The control device may prevent the operation of the fuel cell only to the extent that a minimum state-of-charge of the energy store is guaranteed. Expressed another way, the locomotion of the hybrid vehicle is guaranteed exclusively by the energy store only with regard to a final section of the journey before the expected standstill. In this way, the state-of-charge of the energy store may be prevented from falling below a minimum state-of-charge. The minimum state-of-charge may correspond to the first state-of-charge threshold value, for example.

According to a further aspect, some embodiments of the disclosure also relate to a hybrid vehicle. The hybrid vehicle has at least one fuel cell, an energy store, a state-of-charge sensor, a vehicle interior and/or a luggage compartment, an air-conditioning device which comprises at least one electric heating element, and a control device. The hybrid vehicle is designed, on the basis of the control device, to perform the method as described above.

The advantages which are achieved by the method described herein are also realized in a corresponding manner by the hybrid vehicle presented here.

The fuel cell and the energy store are configured to generate a supply current for a power unit of the hybrid vehicle. This means that locomotion of the hybrid vehicle may be achieved both on the basis of the fuel cell and on the basis of the energy store.

The state-of-charge sensor is optionally designed to detect a state-of-charge of the energy store. The sensor may be coupled to the control device.

Alternatively, the control device may be designed to determine the state-of-charge of the energy store on the basis of at least one measured value detected by the at least one state-of-charge sensor.

Optionally, the air-conditioning device is coupled at least to the vehicle interior and/or the luggage compartment of the hybrid vehicle and designed to heat at least one of the spaces.

The air-conditioning device may include at least one heat exchanger. The heat exchanger is designed to interact at least indirectly with a coolant which is used to cool the fuel cell while it is in operation. In this way, heat which is produced during operation of the fuel cell is fed by the coolant to the heat exchanger, and used by the latter to heat a space in the hybrid vehicle, for example the vehicle interior.

In some embodiments, the air-conditioning device also has the at least one electric heating element. The electric heating element is designed to produce heat on the basis of a supply current. The electric heating element may be a resistance heater, for example.

Optionally, the electric heating element may be coupled at least indirectly to the heat exchanger or integrated therein. Then, advantageously only one heat-conducting connection to the vehicle interior and/or to the luggage compartment of the hybrid vehicle may be provided. The heat-conducting connection may be used both for the heat transfer on the basis of the coolant and on the basis of heat which is produced by the electric heating element, to control the temperature of the vehicle interior and/or of the luggage compartment.

In some examples, the control device may be coupled to a human-machine interface. On the basis of the human-machine interface, the control device may receive user inputs, for example in order to define state-of-charge threshold values. On the basis of the human-machine interface, the control device may also output states of the method outlined herein. In particular, the control device may be designed to indicate, using the human-machine interface, whether a heating operation of the vehicle interior and/or of the luggage compartment of the hybrid vehicle is taking place on the basis of the operation of the fuel cell or the use of the energy store.

Optionally, the control device may also be designed to receive information regarding a planned standstill of the hybrid vehicle via the human-machine interface. The control device may then, for a final section before the planned standstill of the hybrid vehicle, control the powering of the hybrid vehicle in such a way that it takes place exclusively on the basis of the energy store.

The hybrid vehicle may also comprise further sensors, for example temperature sensors, which are designed to detect an outside temperature.

Optionally, the control device may also obtain specifications (user inputs) relating to a desired target temperature of a vehicle interior and/or of a luggage compartment of the hybrid vehicle via the human-machine interface.

In some embodiments, the control device may also be coupled to a sensor which is designed to detect a state-of-charge of the fuel cell.

In addition, the control device may be coupled to a trajectory planner via which it may obtain information about a planned standstill of the vehicle, for example.

Optionally, the hybrid vehicle may also have a cooling device which is designed to cool a vehicle interior and/or a luggage compartment of the vehicle. The control device may then be designed to enable operation of the cooling device which takes place on the basis of a supply current which is guaranteed by the fuel cell.

Preferably, the cooling device, the air-conditioning device, the electric heating element, and/or the heat exchanger may be components of an air-conditioning circuit of the hybrid vehicle. This means that these components may be coupled at least indirectly to one another and the heat currents may be adjusted correspondingly.

Within the meaning of the present disclosure, hybrid vehicles may in particular comprise land vehicles, specifically including all-terrain vehicles and road vehicles such as passenger cars, buses, trucks and other commercial vehicles. Vehicles may be manned or unmanned.

All features explained with regard to the different aspects are combinable individually or in (sub) combination with other aspects.

The following detailed description in connection with the attached drawings, in which identical numbers refer to identical elements, is conceived as a description of different embodiments of the disclosed subject matter and is not intended to represent the only embodiments. Each embodiment described in this disclosure merely serves as an example or illustration and should not be interpreted as being preferred or advantageous over other embodiments. The illustrative examples contained herein do not claim to be complete and do not limit the claimed subject matter to the exact, disclosed forms. Different variations of the described embodiments are readily recognizable to a person skilled in the art, and the general principles defined herein may be applied to other embodiments and applications without departing from the spirit and scope of the described embodiments. Therefore, the embodiments described are not limited to the embodiments shown; rather, they have the greatest possible range of application which is compatible with the principles and features disclosed here.

All of the following features disclosed in relation to the exemplary embodiments and/or the accompanying figures may be combined, alone or in any desired sub combination, with features of the aspects of the present disclosure, including features of preferred embodiments, provided that the resulting combination of features is useful for a skilled person in the field of technology.

For the purposes of the present disclosure, the wording “at least one of A, B and C” means, for example, (A), (B), (C), (A and B), (A and C), (B and C) or (A, B and C), including all further possible combinations, if more than three elements are listed. In other words, the term “at least one of A and B” generally means “A and/or B”, specifically “A” alone, “B” alone or “A and B”.

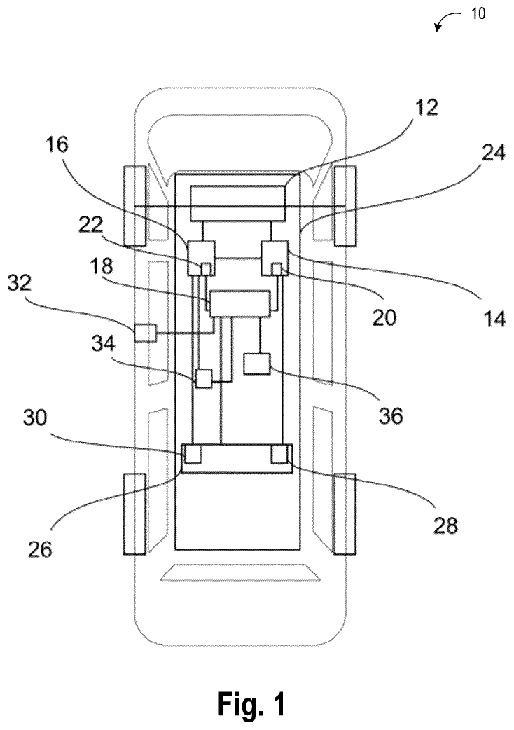

FIG. 1 shows a simplified schematic depiction of a hybrid vehicle 10 according to an embodiment of the present disclosure.

The hybrid vehicle 10 comprises an electric motor 12 which is designed to power the hybrid vehicle 10. The hybrid vehicle 10 additionally comprises an energy store 14, a fuel cell 16, and a control device 18. The control device 18 receives signals from the various sensors of the hybrid vehicle 10 and employs various actuators of the hybrid vehicle 10 to adjust vehicle operation based on the received signals and instructions stored on a memory of the control device 18, as explained in more detail below.

The control device 18 is coupled to the energy store 14. At least one state-of-charge sensor 20 is likewise coupled to the energy store 14 and designed to detect a state-of-charge of the energy store 14, and to transmit it to the control device 18.

Moreover, the control device 18 is coupled to the fuel cell 16. According to this embodiment, a fuel sensor 22 is provided, which is designed to detect a fuel state of the fuel cell 16 and to transmit it to the control device 18.

In addition, the fuel cell 16 is coupled to the energy store 14. The fuel cell 16 is designed to use a fuel, for example hydrogen, on the basis of a chemical reaction, in order to provide an output current which may be used within the onboard electrical system of the hybrid vehicle 10 to charge the energy store 14, for example. The energy store 14 may be configured to store electrical energy and may comprise one or more batteries, capacitors, or the like.

The hybrid vehicle 10 also comprises a vehicle interior 24 in which persons are normally arranged.

In some embodiments, the hybrid vehicle 10 may also comprise a luggage compartment. The luggage compartment (which may be positioned at a rear of the vehicle or a front of the vehicle) may be separated from the vehicle cabin (where the driver and passengers may be positioned) by vehicle interior surfaces or another divider.

The hybrid vehicle 10 additionally comprises an air-conditioning device 26 which is coupled to the control device 18. In the present case, the air-conditioning device 26 has at least one electric heating element 28 and a heat exchanger 30.

The electric heating element 28 is designed to produce heat on the basis of a supply current and to emit the heat to the vehicle interior 24 in order to heat the latter. For this purpose, the electric heating element 28 is coupled at least to the energy store 14, from which the electric heating element 28 may draw the supply current.

In some examples, the electric heating element 28 may additionally be coupled to the fuel cell 16 in order to obtain a supply current.

The heat exchanger 30 is coupled to the fuel cell 16. During operation of the fuel cell 16, a coolant is used in order to dissipate heat which is produced during operation of the fuel cell 16. As a result, the temperature of the fuel cell 16, during operation thereof, may be held in a target range. The heat exchanger 30 is designed to absorb heat from the coolant and to emit the absorbed heat to the vehicle interior 24 in order to heat the latter. Subsequently, the coolant may be returned to the fuel cell 16.

According to this embodiment, the hybrid vehicle 10 also has a temperature sensor 32, which is designed to detect an outside temperature and to is configured to transmit the outside temperature to the control device 18.

According to this embodiment, the hybrid vehicle 10 additionally comprises a cooling device 34, which is coupled both to the control device 18 and to the fuel cell 16. A supply current produced by the operation of the fuel cell 16 may be used in order to operate the cooling device 34, so that a cooling functionality in relation to the vehicle interior 24 is provided. As a result, the temperature in the vehicle interior 24 may be lowered.

In the present case, the hybrid vehicle 10 moreover comprises a human-machine interface 36, which is coupled to the control device 18. On the basis of the human-machine interface 36, the control device 18 may receive user inputs and output sensor measured values, system states or information regarding the operation of the hybrid vehicle 10 for a user.

The control device 18 is generally coupled at least to the energy store 14, to the fuel cell 16, at least to the state-of-charge sensor 20 and to the air-conditioning device 26, in order to appropriately adjust various functions for the operation of the hybrid vehicle 10. For example, the control device 18 may determine and establish whether a supply current for the electric heating element 28 of the air-conditioning device 26 is available on the basis of the energy store 14 and/or the fuel cell 16.

The control device 18 may additionally be coupled to further components, for example to the fuel sensor 22, the temperature sensor 32, the human-machine interface 36 and the cooling device 34. The operation of the hybrid vehicle 10 may then be adjusted based on feedback from the sensors processed at the control device 18.

In further embodiments, the hybrid vehicle 10 may have further components, for example a temperature sensor which is designed to detect a temperature of the vehicle interior 24 and transmit it to the control device 18.

The functionality of the temperature adjustment, which is described hereinafter with respect to the vehicle interior 24, may, in further embodiments, also be provided in relation to a luggage compartment of the hybrid vehicle 10.

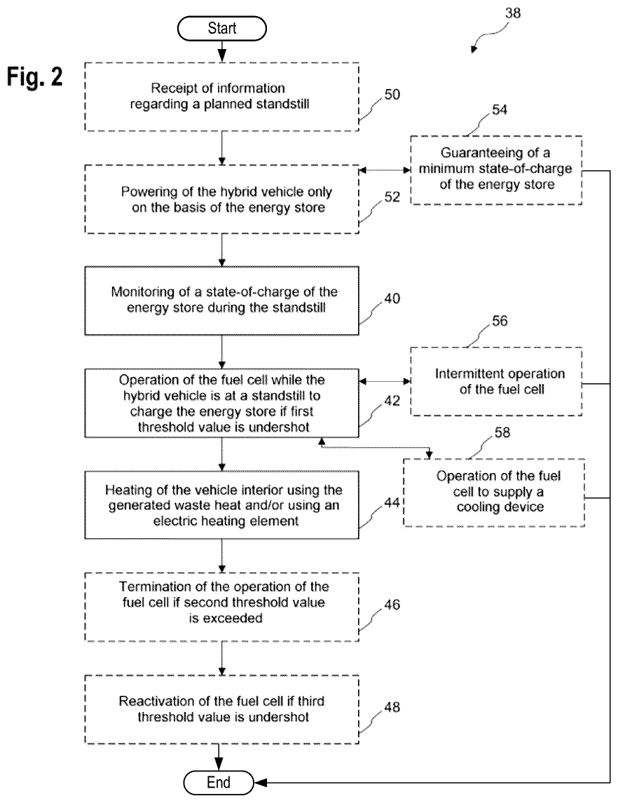

FIG. 2 shows a simplified schematic depiction of a method 38 for operating the hybrid vehicle 10 according to an embodiment of the present disclosure. Optional steps are depicted in dashed form. Instructions for carrying out method 38 and the rest of the methods included herein may be executed by a controller, such as the control device 18, based on instructions stored on a memory of the controller and in conjunction with signals received from sensors of the engine system, such as the sensors described above with reference to FIG. 1, which may include the state-of-charge sensor 20, the temperature sensor 32, the fuel sensor 22, etc. The controller may control the temperature within the vehicle interior 24 by controlling the flow of current to the cooling device 34 and the electric heating element 28.

The method 38 comprises at least 40, at which a state-of-charge of the energy store 14 of the hybrid vehicle 10 is monitored when the hybrid vehicle 10 is at a standstill. In this regard, the state-of-charge sensor 20 may be used, for example, which may transmit corresponding measured values to the control device 18, which may determine a state-of-charge of the energy store 14 on the basis of the measured values.

At 42, the fuel cell 16 is operated to charge the energy store 14 when the hybrid vehicle 10 is at a standstill, at least as long as the state-of-charge of the energy store 14 is below a first state-of-charge threshold value S1. Waste heat is generated by the operation of the fuel cell 16. As used herein, the term standstill may refer to the vehicle being in operation but not moving (e.g., an operator has turned on the vehicle to power at least some of the electrical loads, such as the cooling device 34 or electric heating element 28, but the vehicle is not being propelled). In some examples, standstill may include the vehicle being in a park or neutral gear (e.g., a non-driven gear), or the vehicle may be at a standstill when the vehicle is in a driven gear, but the vehicle is not moving (e.g., due to an operator applying the vehicle wheel callipers). In some examples, the vehicle being at a standstill may include the vehicle being shut off so that no electrical loads are powered other than occasional operation of the control device 18 to monitor the state-of-charge of the energy store 14 and initiate operation of the fuel cell 16 to ensure the state-of-charge of the energy store 14 stays above a minimum threshold.

The method 38 additionally includes 44 at which, in the present case, the vehicle interior 24 of the hybrid vehicle 10 (alternatively: and/or a luggage compartment of the hybrid vehicle 10) is heated using the generated waste heat and/or using an electric heating element 28, for which a first supply current from the energy store 14 is provided. In this way, the first supply current from the energy store 14 may be used to supply current to the electric heating element 28.

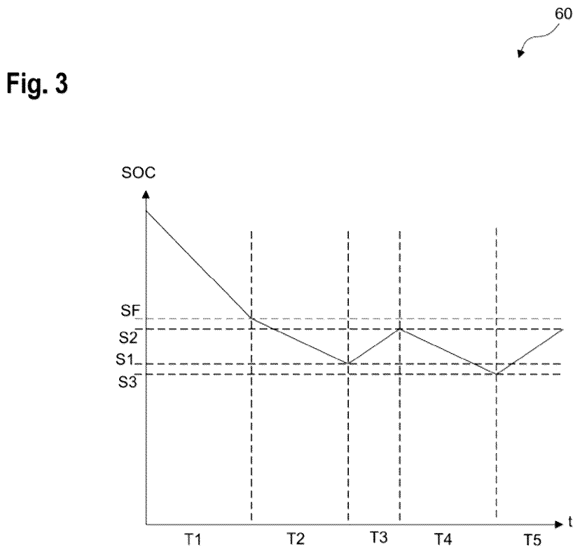

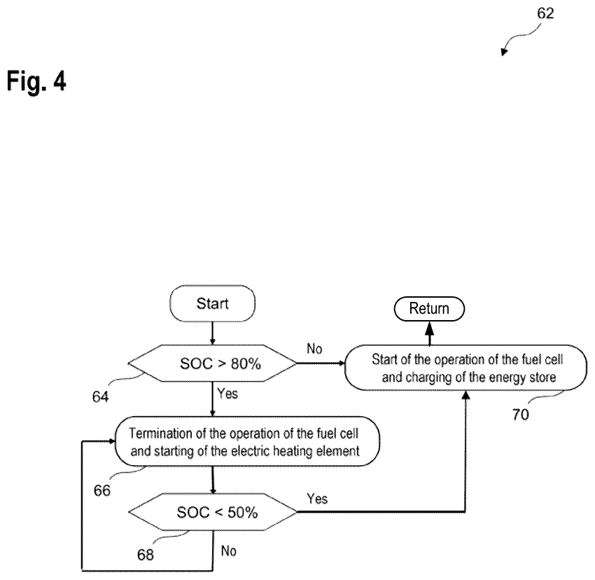

FIG. 3 shows a plot 60 of operating states of the hybrid vehicle 10 in conjunction with the method 38 according to embodiments of the present disclosure. The state-of-charge (SOC) of the energy store 14 is plotted on the Y axis over the time t on the X axis. Time intervals of interest are labelled along the X axis, with boundaries of the time intervals depicted by the dashed vertical lines. SOC values of interest are labelled along the Y axis and depicted by the dashed horizontal lines. FIG. 4 shows a simplified schematic depiction of a process diagram 62 for operating the fuel cell 16 and the electric heating element 28 in conjunction with the method 38 according to an embodiment of the present disclosure.

The beginning of the standstill of the hybrid vehicle 10 corresponds to the beginning of the time interval T2. At this point in time, the state-of-charge of the energy store 14 has the value SF.

At 44, the decision regarding whether the electric heating element 28 is used to heat the vehicle interior 24 may depend on whether the state-of-charge of the energy store 14 is greater than a state-of-charge threshold value, for example greater than the second state-of-charge threshold value S2 (see FIG. 4, which as shown by 64 of FIG. 4 may be 80% of a maximum SOC).

As long as state-of-charge of the energy store 14 is greater than the state-of-charge threshold value, the vehicle interior 24 is then heated using the electric heating element 28 (HE: electric heating element), with the result that the state-of-charge of the energy store 14 lowers starting from the value SF (see FIG. 3, time interval T2 and FIG. 4, where at 66 the operation of the fuel cell is terminated and the electric heating element is started). This means that the vehicle interior 24 is then heated exclusively by means of the electric heating element 28. The operation of the fuel cell 16 is then terminated. It is to be appreciated that in the scenario depicted in FIG. 3, the vehicle is propelled on the basis of the energy in the energy store 14, which causes the SOC to fall during the time interval T1. At the beginning of T2, the standstill is initiated by the operator of the vehicle putting the vehicle into park, but the vehicle is not totally shutdown, as the operator may desire the vehicle interior and/or luggage compartment be maintained in a threshold temperature range. Because the SOC of the energy store 14 is above the second SOC threshold value S2, the fuel cell operation is terminated (if operating) and the electric heating element is operated with a supply current from the energy store 14.

If the condition of the demanded state-of-charge of the energy store 14 is not met (e.g., if the SOC of the energy store is not above the second SOC threshold value S2), the operation of the fuel cell 16 is initiated, see FIG. 4, where at 70 the operation of the fuel cell and the charging of the energy store are started. Thus, when the vehicle is brought to a standstill and the SOC of the energy store is not above the threshold, the fuel cell may be operated to charge the energy store.

When the supply current for operating the electric heating element is provided by the energy store, such as during T2, as soon as the state-of-charge of the energy store 14 falls below the first state-of-charge threshold value S1 (see FIG. 4, where at 68, the SOC relative to the first SOC threshold value S1 is determined, the first SOC threshold value being 50%, for example), operation of the fuel cell 16 is initiated (see FIG. 4, 70). As a result, the state-of-charge of the energy store 14 (ES: energy store) increases during the time interval T3.

Waste heat is also generated as a result of operation of the fuel cell 16. At least the waste heat is used to heat the vehicle interior 24 during the time interval T3.

Optionally, the electric heating element 28 may also be used to heat the vehicle interior 24. When the electric heating element 28 is used in conjunction with the waste heat to heat the vehicle interior 24, the supply current for the electric heating element 28 may be supplied from the fuel cell 16 rather than the energy store 14 during the time interval T3.

The method 38 may optionally include terminating the operation of the fuel cell 16 at 46, as long as the state-of-charge of the energy store 14 exceeds the second state-of-charge threshold value S2 (see FIG. 4, 64). The vehicle interior 24 is then heated exclusively using the electric heating element 28 (see FIG. 4, 66). In the plot 60, the vehicle interior 24 being heated exclusively by the electric heating element 28 corresponds to the time interval T4. During the time interval T4, the state-of-charge of the energy store 14 lowers again, starting from the second state-of-charge threshold value S2, as a result of the provision of a supply current for the electric heating element 28.

The method 38 may additionally optionally comprise 48, in which the operation of the fuel cell 16 is reactivated, responsive to the state-of-charge of the energy store 14 falling below a third state-of-charge threshold value S3. In the plot 60, this corresponds to the time interval T5.

According to the present embodiment, the second state-of-charge threshold value S2 is greater than the first state-of-charge threshold value S1. In addition, the third state-of-charge threshold value S3 is less than the second state-of-charge threshold value S2.

In the present case, the third state-of-charge threshold value S3 is less than the first state-of-charge threshold value S1. In an alternative example, the first state-of-charge threshold value S1 and the third state-of-charge threshold value S3 may also be identical, or the third state-of-charge value S3 may be greater than the first state-of-charge value S1.

By suitably selecting the state-of-charge threshold values S1 to S3, an interval of the state-of-charge of the energy store 14 may be determined, which is guaranteed by activation of the fuel cell 16, while the hybrid vehicle 10 is at a standstill. In this way, the state-of-charge of the energy store 14 may be prevented from becoming too low, even when outside temperatures are continuously low. Expressed another way, the energy store 14 is charged again intermittently, wherein, during the charging intervals, the waste heat generated by the operation of the fuel cell 16 is used to heat the vehicle interior 24.

In some examples, the first state-of-charge threshold value S1 is 50% of the maximum state-of-charge of the energy store 14, the second state-of-charge threshold value S2 is 80% of the maximum state-of-charge of the energy store 14 and the first state-of-charge threshold value S1 and the third state-of-charge threshold value S3 are identical.

For the definition of the state-of-charge threshold values, the control device 18 may obtain corresponding user inputs via the human-machine interface 36. Alternatively, the state-of-charge threshold values may be predefined. In addition, the state-of-charge threshold values may be dependent upon vehicle parameters or external measured values, for example the outside temperature detected by the temperature sensor 32.

Before the hybrid vehicle 10 comes to a standstill, the control device 18 may initiate specific operating modes of the hybrid vehicle 10 in order to save fuel. In this connection, the method 38 may optionally include 50, in which the control device 18 obtains information regarding a planned standstill of the hybrid vehicle 10. For example, the control device 18 may be coupled to a trajectory planner of the hybrid vehicle 10 (e.g., a navigation system, such as GPS) for this purpose or obtain corresponding user inputs via the human-machine interface 36.

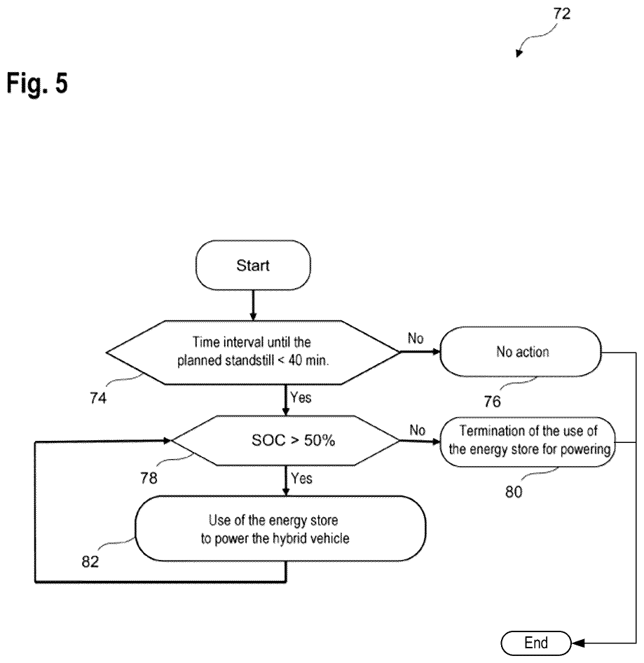

In this connection, FIG. 5 shows a simplified schematic depiction of a process diagram 72 for selecting an energy source for powering the hybrid vehicle 10 in conjunction with the method 38 according to an embodiment of the present disclosure.

In the present case, the decision as to whether the hybrid vehicle 10 is powered exclusively on the basis of the energy store 14 depends on whether a time interval until the planned standstill of the hybrid vehicle 10 is less than a time interval threshold, as shown at 74 of FIG. 5. In some examples, the time interval threshold is 40 minutes. The time interval may be adjustable, for example by a user input via the human-machine interface 36.

If the time until the planned standstill is greater than the time interval threshold (e.g. 40 minutes) at 74, no action takes place, as shown at 76. This means that both the fuel cell 16 and, cumulatively or alternatively, also the energy store 14 may be used to provide a supply current for the electric motor 12 to power the hybrid vehicle 10.

If the time until the planned standstill is less than the time interval threshold (e.g. 40 minutes) at 74, the state-of-charge of the energy store 14 is checked. The state-of-charge sensor 20 may be used for this purpose.

Depending on the state-of-charge of the energy store 14, the control device 18 may adjust the control of the energy source for providing a supply current for the electric motor 12 in accordance with 52 of the method 38.

For this purpose, it is determined whether the state-of-charge of the energy store 14 is greater than a specified state-of-charge threshold value, for example greater than the first state-of-charge threshold value S1, as shown at 78 of FIG. 5. In some examples, the first state-of-charge threshold may be 50% of a maximum SOC.

If the SOC is less than the first state-of-charge threshold value S1 at 78, the energy store 14 is consequently not or no longer used to provide a supply current for the electric motor 12, as shown at 80 of FIG. 5.

If the SOC is greater than the first state-of-charge threshold value S1 at 78, the energy store 14 may be used to power the hybrid vehicle, as shown at 82. In particular, the control device 18 controls the fuel cell 16 and the energy store 14 in such a way that, with knowledge of the standstill of the hybrid vehicle 10, the operation of the electric motor 12 is provided exclusively on the basis of the energy store 14 before the standstill of the hybrid vehicle 10, as long as the SOC is greater than the first state-of-charge threshold value S1.

This means that operation of the fuel cell 16 is terminated during the operation of the electric motor 12 provided exclusively on the basis of the energy store 14 before the standstill of the hybrid vehicle 10, and therefore the fuel cell 16 is not used to provide a supply current for the electric motor 12. Expressed another way, the locomotion of the hybrid vehicle 10 is provided exclusively on the basis of the energy store 14. As a result, with knowledge of the upcoming standstill of the hybrid vehicle 10, fuel may be saved.

The state-of-charge of the energy store 14 is monitored continuously, for example by means of the state-of-charge sensor 20. The state of charge is therefore evaluated repeatedly at 78 and based on the SOC at 78, a decision is made regarding the energy source for powering the electric motor 12.

Optionally, at 54 of the method 38, the control device 18 notes that the operation of the fuel cell 16 is prevented only to the extent that a minimum state-of-charge of the energy store 14 is guaranteed. For example, the minimum state-of-charge of the energy store 14 may correspond to the first state-of-charge threshold value S1. In this way, the fuel cell operation may be terminated when the operation of the electric motor 12 is provided exclusively on the basis of the energy store 14 before the standstill of the hybrid vehicle 10 until the SOC of the energy store falls below the first state-of-charge threshold value S1, at which point the fuel cell may be reactivated.

In a particular embodiment, the minimum state-of-charge of the energy store 14 is 50% of a maximum state-of-charge of the energy store 14.

In addition, the fuel cell 16 may be operated intermittently at 56. Since the operation of the fuel cell 16 produces waste heat, which is dissipated by a corresponding coolant in order to hold the fuel cell 16 in a target temperature range, the intermittent operation may be used in order to guarantee evenness of the coolant temperature. In this way, the fuel cell 16 may be activated and deactivated multiple times during a unit of time, for example one minute. In particular, the intermittent operation of the fuel cell 16 may be designed so that the efficiency of the heat exchanger 30 is optimized, which heat exchanger 30 receives the coolant in order to heat the vehicle interior 24 using the heat of the coolant.

In addition, the method 38 may optionally include 58. At 58 the cooling device 34 of the hybrid vehicle 10 is operated exclusively on the basis of a supply current which is provided by the operation of the fuel cell 16. Cooling devices such as cooling device 34 generally use higher currents in comparison with electric heating elements such as electric heating element 28. This means that operation of the cooling device 34 on the basis of a supply current which is provided by the energy store 14 would lead to a rapid lowering of the state-of-charge of the energy store 14. It is therefore advantageous to operate the cooling device 34 using a supply current which is provided on the basis of the operation of the fuel cell 16. The control device 18 is designed to control the cooling device 34 and at least the fuel cell 16 correspondingly.

Specific embodiments disclosed here, in particular the control device 18, use switching circuits (e.g. one or more switching circuits), in order to implement standards, protocols, methods or technologies disclosed here, to functionally couple two or more components, to produce information, to process information, to analyze information, to produce signals, to code/decode signals, to convert signals, to transmit and/or receive signals, to control other devices etc. Any type of circuit may be used.

In one embodiment, a circuit such as the control device comprises, amongst other things, one or more data processing devices such as a processor (e.g. a microprocessor), a central processing unit (CPU), a digital signal processor (DSP), an application-specific integrated circuit (ASIC), a field-programmable gate array (FPGA), a system on a chip (SoC) or similar or any desired combinations thereof and may comprise discrete digital or analog circuit elements or electronics or combinations thereof. In one embodiment, the circuit comprises hardware circuit implementations (e.g. implementations in analog circuits, implementations in digital circuits and the like and combinations thereof).

In one embodiment, switching circuits comprise combinations of switching circuits and computer program products with software or firmware instructions which are stored on one or more computer-readable memories and interact in order to enable a device to perform one or more of the protocols, methods or technologies described here. In one embodiment, the circuit technology comprises switching circuits, such as e.g. microprocessors or parts of microprocessors, which utilize a software, a firmware and the like for operation. In one embodiment, the switching circuits comprise one or more processors or parts thereof and the associated software, firmware, hardware and the like.

The disclosure also provides support for a method for operating a hybrid vehicle which has a fuel cell and an energy store, comprising: monitoring a state-of-charge of the energy store of the hybrid vehicle when the hybrid vehicle is at a standstill, responsive to the state-of-charge of the energy store being below a first state-of-charge threshold value, operating the fuel cell when the hybrid vehicle is at a standstill to charge the energy store, wherein waste heat is generated by operating the fuel cell, and heating a vehicle interior of the hybrid vehicle and/or a luggage compartment of the hybrid vehicle using the generated waste heat and/or using an electric heating element for which a first supply current from the energy store is provided. In a first example of the method, the operation of the fuel cell is terminated responsive to the state-of-charge of the energy store exceeding a second state-of-charge threshold value, wherein the vehicle interior and/or the luggage compartment is then heated exclusively using the electric heating element. In a second example of the method, optionally including the first example, the second state-of-charge threshold value is greater than the first state-of-charge threshold value. In a third example of the method, optionally including one or both of the first and second examples, the operation of the fuel cell is reactivated, responsive to the state-of-charge of the energy store falling below a third state-of-charge threshold value, wherein the third state-of-charge threshold value is less than the second state-of-charge threshold value. In a fourth example of the method, optionally including one or more or each of the first through third examples, the fuel cell is operated intermittently. In a fifth example of the method, optionally including one or more or each of the first through fourth examples, the hybrid vehicle has an air-conditioning device which is operated at least temporarily using the waste heat and at least temporarily using the first supply current. In a sixth example of the method, optionally including one or more or each of the first through fifth examples, the hybrid vehicle has a cooling device which is operated at least temporarily using a second supply current which is produced by the fuel cell or by the energy store. In a seventh example of the method, optionally including one or more or each of the first through sixth examples, a control device is provided, which controls the operation of the fuel cell and of the energy store, wherein the control device is coupled to a trajectory planner, and wherein the control device, knowing when the standstill of the hybrid vehicle is to occur, prevents operation of the fuel cell before the hybrid vehicle is at the standstill, so that locomotion of the hybrid vehicle is provided exclusively based on the energy store. In an eighth example of the method, optionally including one or more or each of the first through seventh examples, the control device prevents the operation of the fuel cell only to the extent that a minimum state-of-charge of the energy store is guaranteed.

Reference may be made to quantities and numbers in the present application. Unless expressly stated, such quantities and numbers are not to be regarded as being limiting, but rather as being examples for the possible quantities or numbers in relation to the present application. In this connection, the term “plurality” may also be used in the present application in order to refer to a quantity or number. In this connection, the term “plurality” means any number which is greater than one, e.g. two, three, four, five, etc. The terms “about”, “approximately”, “close to” etc. mean plus or minus 5% of the specified value.

Although the disclosure has been depicted and described in relation to one or more embodiments, a person skilled in the art will be able to undertake equivalent amendments and modifications after reading and understanding this description and the attached drawings.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations, and/or functions may be repeatedly performed depending on the particular strategy being used. Further, the described actions, operations, and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for operating a hybrid vehicle which has a fuel cell and an energy store, comprising:
monitoring a state-of-charge of the energy store of the hybrid vehicle when the hybrid vehicle is at a standstill,
responsive to the state-of-charge of the energy store being below a first state-of-charge threshold value, operating the fuel cell when the hybrid vehicle is at the standstill to charge the energy store, wherein waste heat is generated by operating the fuel cell, and
heating a vehicle interior of the hybrid vehicle and/or a luggage compartment of the hybrid vehicle using the generated waste heat and/or using an electric heating element for which a first supply current from the energy store is provided.

2. The method according to claim 1, wherein the operation of the fuel cell is terminated responsive to the state-of-charge of the energy store exceeding a second state-of-charge threshold value, wherein the vehicle interior and/or the luggage compartment is then heated exclusively using the electric heating element.

3. The method according to claim 2, wherein the second state-of-charge threshold value is greater than the first state-of-charge threshold value.

4. The method according to claim 2, wherein the operation of the fuel cell is reactivated, responsive to the state-of-charge of the energy store falling below a third state-of-charge threshold value, wherein the third state-of-charge threshold value is less than the second state-of-charge threshold value.

5. The method according to claim 2, wherein the fuel cell is operated intermittently.

6. The method of claim 1, wherein the hybrid vehicle has an air-conditioning device which is operated at least temporarily using the waste heat and at least temporarily using the first supply current.

7. The method of claim 1, wherein the hybrid vehicle has a cooling device which is operated at least temporarily using a second supply current which is produced by the fuel cell or by the energy store.

8. The method of claim 1, wherein a control device is provided, which controls the operation of the fuel cell and of the energy store, wherein the control device is coupled to a trajectory planner, and wherein the control device, knowing when the standstill of the hybrid vehicle is to occur, prevents operation of the fuel cell before the hybrid vehicle is at the standstill, so that locomotion of the hybrid vehicle is provided exclusively based on the energy store.

9. The method of claim 8, wherein the control device prevents the operation of the fuel cell only to the extent that a minimum state-of-charge of the energy store is guaranteed.

10. A hybrid vehicle comprising;
a fuel cell;
an energy store,
a state-of-charge sensor,
a vehicle interior and/or a luggage compartment,
an air-conditioning device which includes an electric heating element, and
a control device configured to:
monitor, based on output from the state-of-charge sensor, a state-of-charge of the energy store of the hybrid vehicle when the hybrid vehicle is at a standstill,
operate the fuel cell when the hybrid vehicle is at the standstill to charge the energy store, at least as long as the state-of-charge of the energy store is below a first state-of-charge threshold value, wherein waste heat is generated by operating the fuel cell, and
heat the vehicle interior of the hybrid vehicle and/or the luggage compartment of the hybrid vehicle using the generated waste heat and/or using the electric heating element for which a first supply current from the energy store is provided.
